(19) United States
(12) Patent Application Publication
(10) Pub. No.: US 2009/0115657 A1
(43) Pub. Date: May 7, 2009

(54) GNSS RECEIVER SYSTEM AND RELATED METHOD THEREOF

(76) Inventors: Ann-Tzung Cheng, Taipei County (TW); Kung-Shuan Huang, Changhua County (TW); Chih-Ju Tai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/935,417

(22) Filed: Nov. 6, 2007

(51) Int. Cl. G01S 1/00

(52) U.S. Cl. 342/357.06

(57) ABSTRACT

A global navigation satellite system (GNSS) receiver system includes a first mobile GNSS receiver and a second mobile GNSS receiver. The first mobile GNSS receiver includes: a first receiver logic for receiving satellite signals and determining positioning related information according to the satellite signals; a data provider logic for providing at least an assisted data according to the positioning related information; and a first communication interface for outputting the assisted data. The second mobile GNSS receiver includes a second communication interface, for communicating with the first communication interface to receive the assisted data from the communication interface; a data collector logic for collecting assisted information from the assisted data; and a second receiver logic for determining positioning information of the second mobile GNSS receiver according to the assisted information and satellite signals.

### BACKGROUND

The present invention relates to determining positioning information of an electronic device, and more particularly, to a global navigation satellite system (GNSS) receiver system and related method for determining positioning information of a GNSS receiver according to assisted data received from at least a neighboring GNSS receiver and satellite signals received from GNSS satellites.

Along with today's dramatic development in personal, mobile communication devices, a variety of additional services are supported. In particular, some countries have mandated the use of positioning service, such as GPS function, in mobile phones to provide location-based services to users. In general, a GPS receiver on the ground is required to search satellites visible in an open sky after a cold start for collecting ephemeris from tracked satellites. This search process, however, is a dominant time-consuming factor that determines the time to first fix (TTFF).

Recently, the Assisted-GPS (A-GPS) is widely used to enable a GPS receiver to receive auxiliary data, such as ephemeris and timing information, from a base station via a mobile communication network. Therefore, information of all visible satellites is immediately available to the GPS receiver. With the help of the auxiliary data, the GPS receiver can quickly detect and acquire the signals of visible satellites. For example, positioning operation can be accelerated by determining a default position for the GPS receiver and by transmitting it to the GPS receiver through the conventional A-GPS service. Regarding the default position, it is possible to use the position of a base station close to the GPS receiver to serve as the default position of the GPS receiver. Consequently, this default position provides a kind of an initial guess for the actual position of the GPS receiver, which accelerates the determination of the visible satellites and reduces the time taken for the acquisition of the satellite signals. Thus, the TTFF is reduced accordingly.

A problem in such an arrangement is, however, that it requires the transmission of auxiliary data through a mobile communication network as the auxiliary data is given from a remote and immobile base station. As a result, the auxiliary data is not necessarily available to mobile GPS receivers, for example, installed on cellular phones or automobiles everywhere.

### SUMMARY OF THE INVENTION

It is therefore one of the objectives of the present invention to provide a global navigation satellite system (GNSS) receiver system and related method for determining positioning information of a GNSS receiver according to assisted data received from neighboring GNSS receiver(s) and satellite signals received from GNSS satellites.

According to one aspect of the present invention, a global navigation satellite system (GNSS) receiver system is provided. The GNSS receiver system comprises a first mobile GNSS receiver and a second mobile GNSS receiver. The first mobile GNSS receiver includes: a first receiver logic, for receiving satellite signals and determining positioning related information according to the satellite signals; a data provider logic, coupled to the first receiver logic, for providing at least an assisted data according to the positioning related information; and a first communication interface, coupled to the data provider logic, for outputting the assisted data. The second mobile GNSS receiver includes: a second communication interface, for communicating with the first communication interface to receive the assisted data from the communication interface; a data collector logic, for collecting assisted information from the assisted data; and a second receiver logic, for determining positioning information of the second mobile GNSS receiver according to the assisted information and satellite signals.

According to another aspect of the present invention, a method of determining positioning information of a second mobile GNSS receiver. The method comprises: providing a first mobile GNSS receiver; utilizing the first mobile GNSS receiver to determine at least an assisted data associated with positioning of the second mobile GNSS receiver according to satellite signals and then output the assisted data; and receiving the assisted data from the first mobile GNSS receiver and referring to the assisted data and satellite signals for determining the positioning information of the second mobile GNSS receiver.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a global navigation satellite system (GNSS) receiver system according to an exemplary embodiment of the present invention.

FIG. 2 is a flowchart illustrating operation of providing assisted data used for reducing time to first fix (TTFF) according to an embodiment of the present invention.

FIG. 3 is a flowchart illustrating operation of collecting assisted data used for reducing the TTFF according to an embodiment of the present invention.

FIG. 4 is a diagram illustrating a sequence of data transaction between a data provider logic and a data collector logic.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

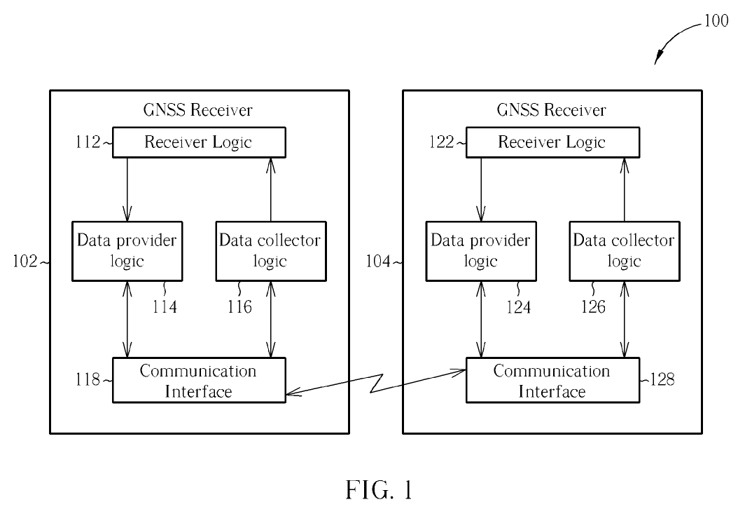

Please refer to FIG. 1. FIG. 1 is a block diagram illustrating a global navigation satellite system (GNSS) receiver system 100 according to an exemplary embodiment of the present invention. The GNSS receiver system 100 includes a plurality of GNSS receivers each supporting a specific GNSS system, such as GPS, Galileo, or GLONASS. For simplicity, only two mobile GNSS receivers 102 and 104 are shown in FIG. 1. The mobile GNSS receivers 102 and 104 can be disposed on or attached to any mobile apparatuses, such as cellular phones, personal digital assistants (PDAs), and automobiles. The GNSS receiver 102 includes, but is not limited to, a receiver logic 112, a data provider logic 114, a data collector logic 116, and a communication interface 118. Similarly, the GNSS receiver 104 includes, but is not limited to, a receiver logic 122, a data provider logic 124, a data collector logic 126, and a communication interface 128. As shown in FIG. 1, both GNSS receivers 102 and 104 have the same hardware configuration. However, this is for illustrative purpose only, and is not meant to be a limitation of the present invention. For example, each GNSS receiver in the GNSS receiver system 100 is not limited to have both the data provider logic and data collector logic. The GNSS receiver system 100 works as desired when one of the GNSS receivers 102 and 104 includes a data provider logic and the other of the GNSS receivers 102 and 104 includes a data collector logic. This is self-explanatory in view of following paragraphs.

In this embodiment of the present invention, the receiver logic 112, 122 is capable of performing normal GNSS receiver functions. For example, the receiver logic 112, 122 includes an receiver module for receiving RF signals (i.e., satellite signals) from tracked satellites and then converting the received RF signals into baseband signals for further signal processing, a processor for processing the baseband signals to obtain positioning related information and computing positioning information of the GNSS receiver, and a memory for buffering data generated or processed by the processor. As the operation and functionality of determining the positioning information according to satellite signals are well known to those skilled in this art, further description is omitted here for the sake of brevity. It should be noted that the receiver logic 112, 122 supports the function of referring to assisted data for quickly completing the positioning operation after a cold start of the GNSS receiver 102, resulting in reduced TTFF. The data provider logic 114, 124 is implemented to provide at least an assisted data according to the positioning related information obtained by the receiver logic 112. In this embodiment, based upon the size or type of assisted information included in the assisted data, the data provider logic 114, 124 selectively provides the assisted data to the communication interface 118, 128 when requested on demand or automatically broadcasts the assisted data through the communication interface 118, 128. For example, the positioning related information with small data size (e.g., identification information of the currently tracked satellites) will be broadcasted by the communication interface 118, 128 via advertisement messages, automatically. In this embodiment, the assisted data given by the data provider logic 114, 124 includes, but is not limited to, identification information of the tracked satellites, almanac, ephemeris of the currently tracked satellites, current universal coordinated time (UTC), position of the GNSS receiver 102, 104 on which the data provider logic 114, 124 is disposed, the PRN code of each satellite visible in the geographic area, healthy satellite information, and/or Doppler and code chip information. However, these are for illustrative purposes only. In practical design, without departing from the spirit of the present invention, any auxiliary information referenced by the receiver logic 112, 122 for shortening the TTFF can be included in the assisted data provided by the data provider logic 114, 124.

The data collector logic 116, 126 is implemented to collect assisted information included in the assisted data received by the communication interface 118, 128, and then provide the collected assisted information to the receiver logic 112, 122 for accelerating the positioning operation. The communication interfaces 118 and 128 are used for establishing a communication link therebetween. For example, the communication interfaces 118 and 128 establish a wireless communication link through a WLAN connection, a Bluetooth connection, an IrDA connection, or an Ad-Hoc network connection. However, these are for illustrative purposes only, and are not meant to be limitations of the present invention. In other words, without departing the spirit of the present, any wired or wireless connections capable of linking different GNSS receivers in the GNSS receiver system 100 for data transaction can be adopted.

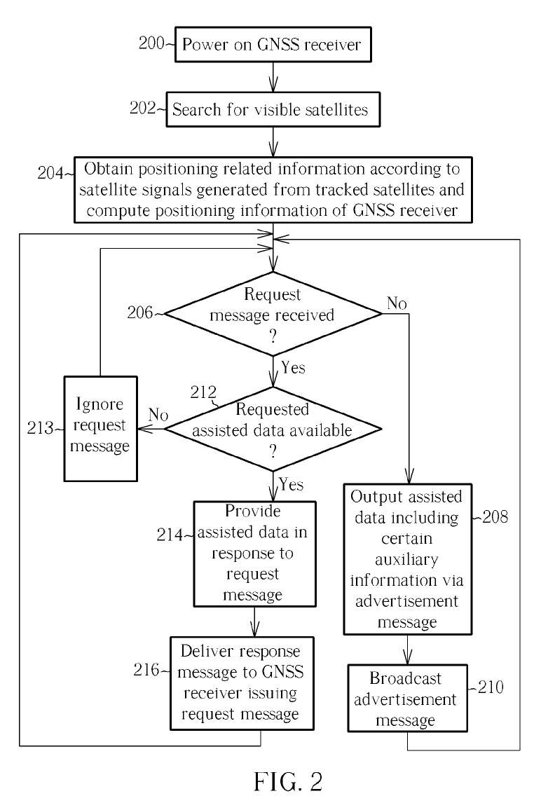

Please refer to FIG. 2. FIG. 2 is a flowchart illustrating operation of providing assisted data used for reducing the TTFF according to an embodiment of the present invention. If the result is substantially the same, the steps are not limited to be executed in the exact order shown in FIG. 2. The operation of providing the assisted data includes following steps.
Step 200: Power on the GNSS receiver 102, 104.
Step 202: The receiver logic 112, 122 searches the sky for visible satellites.
Step 204: The receiver logic 112, 122 obtains positioning related information according to satellite signals generated from tracked satellites and computes the positioning information of the GNSS receiver 102, 104.
Step 206: Is a request message for assisted data received by the communication interface 118, 128? If yes, go to step 212; otherwise, proceed with step 208.
Step 208: The data provider logic 114, 124 outputs assisted data including certain auxiliary information via at least an advertisement message.
Step 210: The communication interface 118, 128 broadcasts the advertisement message received from the data provider logic 114, 124. Go to step 206.
Step 212: The data provider logic 114, 124 determines if the receiver logic 112, 122 has the requested assisted data. If yes, proceed with step 214; otherwise, go to step 213.
Step 213: Ignore the request message, and then go to step 206 to keep monitoring if a new request message is received.
Step 214: The data provider logic 114, 124 provides the assisted data in response to the request message.
Step 216: The communication interface 118, 128 delivers at least a response message, including the requested assisted data, to a GNSS receiver issuing the request message. Go to step 206.

Taking the GNSS receiver 102 for example, the data provider logic 114 checks if there is any request message received by the communication interface 118 after the GNSS receiver 102 has been powered on for a while (steps 200-206). At this moment, the receiver logic 112 has obtained positioning related information according to satellite signals from tracked satellites. As stated above, the positioning related information could include identification information of the currently tracked satellites, almanac, ephemeris of the currently tracked satellites, current universal coordinated time (UTC), position of the GNSS receiver 102, the PRN code of each satellite visible in the geographic area, healthy satellite information, and/or Doppler and code chip information. In this embodiment, when no request message asking for assisted data is received, the data provider logic 114 enters a broadcast mode. In the broadcast mode, the data provider logic 114 generates advertisement message(s) according to positioning related information available in the receiver logic 112. For example, the advertisement message includes identification information of the satellites currently tracked by the GNSS receiver 102 in which the data provider logic 114 is disposed (step 208). Next, the data provider logic 114 transmits the advertisement message, including the identification information of the currently tracked satellites, to the communication interface 118, and the communication interface 118 broadcasts the advertisement message. Therefore, any neighboring GNSS receiver, such as the GNSS receiver 104, can obtain the identification information of the currently tracked satellites after successfully receiving the advertisement message broadcasted in the air.

In a case where the communication interface 118 receives a request message from an external GNSS receiver (e.g., the GNSS receiver 104), the data provider logic 114 first checks if the requested assisted data is available, for example, in a memory of the receiver logic 112 (step 212). When the receiver logic 112 does not have the requested assisted data, the data provider logic 114 directly ignores the request message (step 213). However, when the receiver logic 112 has the requested assisted data, the data provider logic 114 retrieves auxiliary information requested by the request message from the receiver logic 112 and then generates a response message including the requested assisted data (step 214). Next, the data provider logic 114 transmits the response message to the communication interface 118, and the communication interface 118 forwards the response message to the GNSS receiver issuing the request message (step 216). In this embodiment, the response message can be delivered to the GNSS receiver issuing the request message via a broadcast means or unicast means, depending upon design requirements. In other words, any conventional means for transmitting the response message from a data provider to a data requester can be adopted by the GNSS receiver system 100.

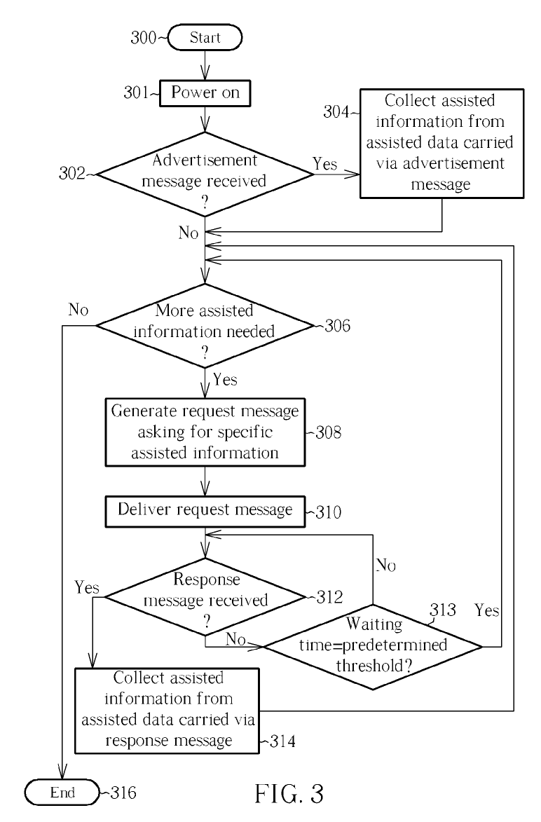

Please refer to FIG. 3. FIG. 3 is a flowchart illustrating operation of collecting assisted data used for reducing the TTFF according to an embodiment of the present invention. If the result is substantially the same, the steps are not limited to be executed in the exact order shown in FIG. 3. The operation of collecting the assisted data includes following steps.
Step 300: Start.
Step 301: Power on the GNSS receiver 102, 104.
Step 302: Is at least an advertisement message received by the communication interface 118, 128? If yes, proceed with step 304; otherwise, go to step 308.
Step 304: The data collector logic 116, 126 collects assisted information from assisted data carried via the advertisement message(s) and provides the assisted information to the receiver logic 112, 122.
Step 306: Does the data collector logic 116, 126 need to gather more assisted information? If yes, proceed with step 308; otherwise, go to step 316.
Step 308: The data collector logic 116, 126 generates a request message asking for specific assisted information.
Step 310: The communication interface 118, 128 delivers the request message.
Step 312: Is a response message corresponding to the request message is received by the communication interface 118, 128? If yes, go to step 314; otherwise, proceed with step 313.
Step 313: Does the accumulated waiting time for the response message reach a predetermined threshold? If yes, go to step 306; otherwise, go to step 312 to keep waiting for the response message.
Step 314: The data collector logic 116, 126 collects assisted information from assisted data carried via the response message and provides the assisted information to the receiver logic 112, 122. Go to step 306.
Step 316: End.

Taking the GNSS receiver 104 for example, the data collector logic 126 checks if there is any advertisement message received by the communication interface 128 after the GNSS receiver 104 has a cold start (steps 300-302). When at least an advertisement message, provided by a neighboring GNSS receiver in the GNSS receiver system 100, is successfully received by the communication interface 128, the data collector logic 126 is actuated to collect assisted information included in the assisted data carried via the received advertisement message, and then delivers the assisted information to the receiver logic 122 to aid the receiver logic 122 in locating satellites visible in the substantially the same geographic area in which the neighboring GNSS receiver which provides the assisted data is located.

When there is no advertisement message or the data collector logic 126 still needs to gather more assisted information for the receiver logic 122 (step 302 or 306), the data collector logic 126 is configured to generate one or more request messages for requesting neighboring GNSS receivers for more assisted information (steps 308-314). For instance, the data collector logic 126 generates a first request message to ask for PRN codes of the satellites visible in the sky or the current universal coordinated time; and then generates a second request message to ask for almanac and ephemeris or information associated with dilution of precision (DOP).

It should be note that it is possible that all of the neighboring GNSS receivers do not have the requested assisted data. Therefore, step 313 is included in the flow in FIG. 3 to provide a mechanism to abort waiting for a response message generated in response to a corresponding request message.

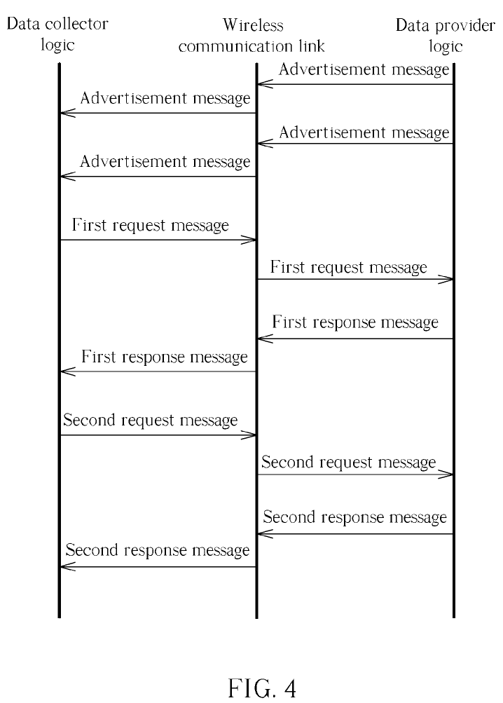

To more clearly illustrate features of the present invention, please refer to FIG. 4, which is a diagram illustrating a sequence of data transaction between a data provider logic (e.g., the data provider logic 114 of the GNSS receiver 102 shown in FIG. 1) and a data collector logic (e.g., the data collector logic 126 of the GNSS receiver 104 shown in FIG. 1). The data provider logic communicates with the data collector logic through a wireless communication link established therebetween. After receiving the assisted information given by the data provider logic on one GNSS receiver, the receiver logic positioned on another GNSS receiver can quickly fix the first location after cold start. As the operation and function of the data provider logic and the data collector logic have been detailed above, further description directed to the example shown in FIG. 4 is omitted here for the sake of brevity.

Those skilled in the art will readily observe that numerous modifications and alterations of the device and method may be made while retaining the teachings of the invention.

What is claimed is:

1. A global navigation satellite system (GNSS) receiver system, comprising:
a first mobile GNSS receiver, comprising:
a first receiver logic, for receiving satellite signals and determining positioning related information according to the satellite signals;
a data provider logic, coupled to the first receiver logic, for providing at least an assisted data according to the positioning related information; and
a first communication interface, coupled to the data provider logic, for outputting the assisted data; and
a second mobile GNSS receiver, comprising:
a second communication interface, for communicating with the first communication interface to receive the assisted data from the communication interface;
a data collector logic, coupled to the second communication interface, for collecting assisted information from the assisted data; and
a second receiver logic, coupled to the data collector logic, for determining positioning information of the second mobile GNSS receiver according to the assisted information and satellite signals.

2. The GNSS receiver system of claim 1, wherein the first communication interface outputs the assisted data through broadcasting at least an advertisement message.

3. The GNSS receiver system of claim 1, wherein the data collector logic generates a request message for the assisted data and the second communication interface further outputs the request message; and the first communication interface further receives the request message and the data provider logic provides the assisted data in response to the request message.

4. The GNSS receiver system of claim 1, wherein the first communication interface communicates with the second communication interface through a wireless communication link.

5. A method of determining positioning information of a second mobile GNSS receiver, comprising:
utilizing a first GNSS receiver to determine at least an assisted data associated with positioning of the second mobile GNSS receiver according to satellite signals and then output the assisted data; and
receiving the assisted data from the first GNSS receiver and referring to the assisted data and satellite signals for determining the positioning information of the second mobile GNSS receiver.

6. The method of claim 5, wherein the step of utilizing the first GNSS receiver to output the assisted data comprises broadcasting at least an advertisement message to output the assisted data.

7. The method of claim 5, further comprising:
generating a request message for the assisted data; and
outputting the request message;
wherein the step of utilizing the first GNSS receiver to determine the assisted data comprises:
utilizing the first GNSS receiver to receive the request message and then provide the assisted data in response to the request message.

8. The method of claim 5, wherein the assisted data is transmitted through a wireless communication link between the first GNSS receiver and the second mobile GNSS receiver.
